(19) United States
(12) Patent Application Publication
(10) Pub. No.: US 2019/0302834 A1
(43) Pub. Date: Oct. 3, 2019

(54) AIRFLOW DEVICE FOR A VIRTUAL REALITY HEADSET

(71) Applicant: Walmart Apollo, LLC, Bentonville, AR (US)

(72) Inventors: John Jeremiah O'Brien, Farmington, AR (US); Donald Ray High, Noel, MO (US); ChandraShekar Natarajan, San Ramon, CA (US)

(21) Appl. No.: 16/369,272

(22) Filed: Mar. 29, 2019

Related U.S. Application Data
(60) Provisional application No. 62/649,773, filed on Mar. 29, 2018.

(51) Int. Cl. G06F 1/16; G06T 7/70; G06F 3/14; G06T 7/20; G05B 15/02

(52) U.S. Cl. CPC G06F 1/163; G06T 7/70; G06T 2207/10016; G06T 7/20; G05B 15/02; G06F 3/14

(57) ABSTRACT

An airflow device for a head-mounted virtual reality headset and associated methods for controlling the airflow device to reduce motion sickness symptoms in a user is discussed.

### RELATED APPLICATION

This application claims priority to U.S. Provisional Application No. 62/649,773, filed on Mar. 29, 2018, the contents of which are hereby incorporated by reference in its entirety.

### BACKGROUND

A virtual-reality headset is a specific form of a head-mounted display that is a worn on a head of a user and presents images on a screen or projects images directly onto the retinas of the user. By wearing the virtual-reality headset, the user visually immerses himself or herself in a virtual world. The virtual world can give the user an impression that the user is moving in a three-dimensional world, even when the user is physically static.

### BRIEF DESCRIPTION OF THE DRAWINGS

To assist those of skill in the art in making and using the system and associated methods described herein, reference is made to the accompanying figures. The accompanying figures, which are incorporated in and constitute a part of this specification, illustrate one or more embodiments of the present disclosure and, together with the description, help to explain the present disclosure. Illustrative embodiments are shown by way of example in the accompanying drawings and should not be considered as limiting. In the figures:

FIG. 1 illustrates an internal view of a housing for an airflow device for a virtual reality headset to reduce motion sickness symptoms in a user, in accordance with an exemplary embodiment;

FIG. 2 illustrates an external view of the housing shown in FIG. 1, in accordance with an exemplary embodiment;

FIG. 3 illustrates the housing attached to a virtual reality headset worn by a user in an exemplary embodiment; and

FIG. 4 is a flowchart illustrating an exemplary method for controlling the airflow device for a virtual reality headset to reduce motion sickness symptoms in a user, in accordance with an exemplary embodiment.

### DETAILED DESCRIPTION OF EMBODIMENTS

An airflow device for a head-mounted virtual reality headset and associated methods for controlling the airflow device to reduce motion sickness symptoms in a user are discussed herein. In one exemplary embodiment an airflow device is configured for use with a head-mounted virtual reality headset that displays a virtual environment. The airflow device includes a first housing and a second housing. The first housing includes a first arm coupled to a first circular base. In one embodiment the first circular base is configured to at least substantially overlay a first ear of a user. A first air intake port within the first arm channels air into the first housing and at least one motor within the first arm accelerates airflow and increases air pressure. At least one air outtake port within the first circular base releases air from the first circular base such that the air flows by the first ear of the user in a single direction. At least one servo within the first circular base controls the airflow to the at least one air outtake port. A processor communicatively coupled to the virtual reality headset analyzes image-sequence information displayed by the virtual reality headset to control the at least one servo. The control of the airflow provided via the at least one servo is dependent on detected spatial positioning of the image-sequence information.

The exemplary embodiment also includes a second housing that includes a second arm coupled to a second circular base. In an embodiment the second circular base is configured to at least substantially overlay a second ear of the user. A second air intake port within the second arm channels air into the second housing and at least one motor within the second arm accelerates airflow and increases air pressure. At least one air outtake port within the second circular base releases air from the second circular base such that the air flows by the second ear of the user in a single direction. At least one servo within the second circular base controls the airflow to the at least one air outtake port. The processor analyzes image-sequence information displayed by the virtual reality headset to control the at least one servo. The control of the airflow provided via the at least one servo is dependent on detected spatial positioning of the image-sequence information.

In one embodiment, the virtual reality headset and/or the airflow device includes at least one accelometer and/or at least one positioning sensor for motion detection of the head of the user. In such an embodiment, the processor is communicatively coupled to the at least one accelometer and/or the at least one positioning sensor. The control of the at least one servo within the first circular base and the second circular base is at least partial dependent on the detected spatial positioning determined by the accelometer and/or the positioning sensor. This enables the airflow to be adapted to the head movements of the user of the virtual reality headset.

In one embodiment, the first circular base and the second circular base each includes a plurality of air outtake ports to channel the air that entered the housing through the air intake ports. Each air outtake port has an airflow controlled by at least one servo located within the housing. The first circular base and the second circular base includes hinge-expressed airflow controls connected to the at least one servo for variable airflow control. The hinge-expressed airflow controls are hinges that are adjustable so that they can be adjusted to control a release and a discharge direction of the airflow based on the detected spatial movement of the virtual reality headset and/or displayed image-sequence information in the virtual reality headset. Each air outtake port releases air from the circular base in a different direction over an ear of the user. The outflow direction of the airflow depends on a virtual movement of the user of the virtual reality headset with respect to the virtual display. The virtual movement is movement within the virtual environment (for example, forward movement within the virtual environment).

In an exemplary embodiment, each of the first circular base and the second circular base includes four air outtake ports. For example, in an exemplary embodiment, each air outtake port emits air in a direction approximately 90 degrees different from the nearest adjacent air outtake port.

In one embodiment, the housing is integrated with the virtual reality headset.

In another embodiment, each of the first housing and the second housing further includes at least one connector connecting the first housing and the second housing to the virtual reality headset. In such an embodiment, the first circular base and the second circular base are configured to be substantially aligned with the first ear and the second ear, respectively, of the user when the housings are connected to the virtual reality headset.

In one embodiment, a head mounted band is attached to the first housing and the second housing. The head mounted band is configured to be worn on a head of the user and each of the first circular base and the second circular base is configured to be substantially respectively aligned with the first ear and the second ear of the user.

In one embodiment, the processor is configured to control the at least one servo such that a direction of the airflow is opposite to a virtual direction of movement of the user as determined by the image-sequence information. For example, when the user is identified as moving in direction x in the virtual reality environment as identified by the processor analyzing image sequence information from the virtual reality environment, a direction of the airflow is counter to x over the first and second earof the user to simulate physical movement of the user.

In one embodiment, the airflow device further includes at least one motor within each of the the first circular base and the second circular base for accelerating airflow and increasing air pressure within the first circular base and the second circular base.

The airflow device provides an airflow to a user of a virtual-reality headset corresponding to virtual movement in a virtual environment to reduce motion sickness symptoms in a user. The airflow is dependent on virtual movement in the virtual environment and reflects airflow as would physically occur in reality, but that otherwise does not occur in a virtual environment as the participant is usually not physically moving. This control of airflow results in a realistic perception of the virtual environment and reduces motion sickness symptoms in the user.

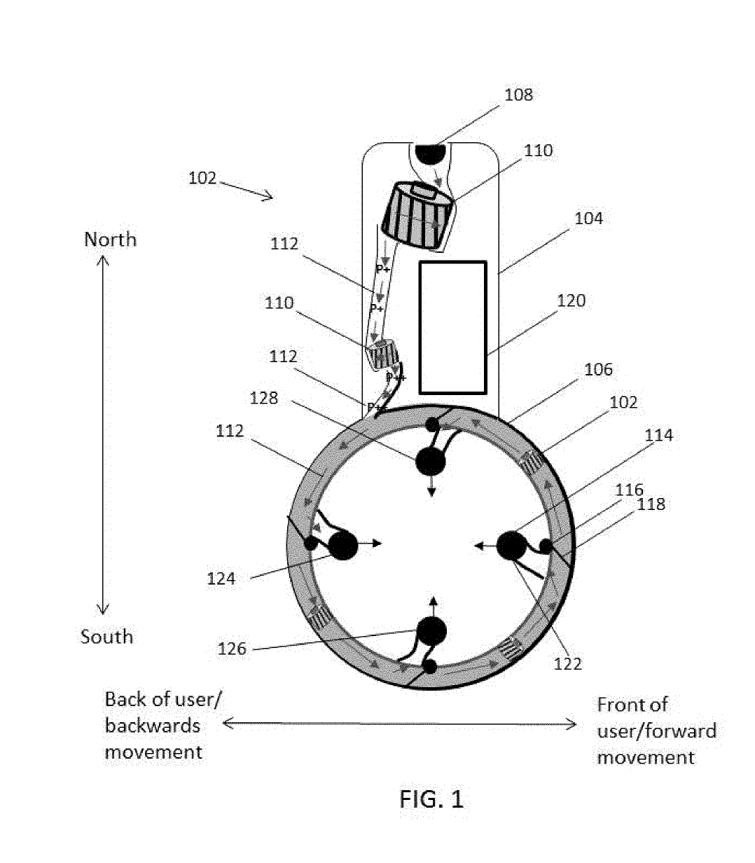

FIG. 1 illustrates an internal view of a housing 102 for an airflow device for a virtual reality headset to reduce motion sickness symptoms in a user, in accordance with an exemplary embodiment. The airflow device exposes a user of the virtual reality headset to an airflow, as described herein. The airflow emitted by the airflow device is controllable based on the images displayed by the virtual reality headset. The airflow acts as a function of a detected spatial movement of the virtual reality headset and/or as a function of image-sequence information displayed in the virtual reality headset.

The housing 102 includes an arm 104 coupled to a circular base 106. The circular base 106 configured to at least substantially overlay an ear of a user. In one embodiment the circular base 106 is configured to encompass the ear of the user. The housing 102 includes an air intake port 108 in the arm 104 for channeling air into the housing 102. The housing 102 includes at least one motor 110 within the arm 104 for accelerating airflow and increasing air pressure within the arm 104 and the circular base 106 (shown at 112). The housing 102 includes at least one air outtake port 114 in the circular base 106 for releasing air from the circular base 106 such that the airflows by the ear of the user in a single direction.

The housing 102 includes at least one servo 116 within the circular base 106 for controlling the airflow to the at least one air outtake port 114. The airflow direction is adjustable using hinge-expressed airflow controls 118 controllable by the at least one servo 116. The hinge-expressed airflow controls 118 are hinges that are adjustable so that they can be adjusted to influence the discharge direction based on the detected spatial movement of the virtual reality headset and/or displayed image-sequence information in the virtual reality headset.

In one embodiment, the housing 102 includes at least one processor 120 communicatively coupled to the virtual reality headset and/or a source of the image-sequence information displayed in the virtual reality headset (for example, a computer device feeding the image-sequence information to the virtual reality headset). In one embodiment, the at least one processor 120 analyzes image-sequence information displayed by the virtual reality headset to control the at least one servo 114. The control of the at least one servo 114 is thus dependent on detected spatial positioning of the image-sequence information. The processor 120 is configured to control the at least one servo 114 such that a direction of the airflow is opposite to an identified virtual direction of movement of the user as determined by the image-sequence information. In some embodiments, the airflow device includes sensors for motion detection of the head and the detected sensor information is also used to control airflow direction.

As noted above, the airflow, as controlled by the processor 120, is dependent on a detected spatial movement of the virtual reality headset and/or the displayed image-sequence information in the virtual reality headset. For example, when the user rotates the virtual reality headset (for example, the user rotates his head to the left), the perspective changes within the virtual environment. In response to the changes within the virtual environment, the outflow direction of the airflow is controlled such that airflow corresponds to the head movement and the displaying of the virtual environment. This contributes to perceiving the virtual environment as more realistic.

In one embodiment, a strength of the airflow via the housing 102 is dependent on a detected movement speed of the virtual reality headset and/or as a function of a detected movement speed of the image-sequence information displayed in the virtual reality headset. Depending on the detected speed, the airflow provided by the housing 102 can be adapted in strength, such that the virtual environment feels more realistic. For example, in one embodiment, the hinges of the hinge-expressed airflow controls are adjustable so that they can be adjusted to control a discharge strength of the airflow.

In an exemplary embodiment, the circular base 106 includes four air outtake ports 114. Each air outtake port 114 releases air from the circular base 106 in a different direction over the ear of the user. Each air outtake port 114 emits air in a direction approximately 90 degrees different from the nearest adjacent air outtake port 114.

For example, when the user is moving forward in the virtual environment, air outtake port 122 emit air in the opposing direction, such that air is flowing from a front of the user to a back of the user. When the user is moving backwards in the virtual environment, air outtake port 124 emits air in the opposing direction, such that air is flowing from the back of the user to the front of the user. When the user is moving downwards in the virtual environment, air outtake port 126 emits air in the opposing direction, such that air is flowing from south to north. When the user is moving upwards in the virtual environment, air outtake port 128 emits air in the opposing direction, such that air is flowing from north to south.

In some embodiments, the housing 102 further includes at least one additional motor within the circular base 106 for accelerating airflow and increasing air pressure within the circular base 106.

In an exemplary embodiment, there is a separate housing for each ear of the user. For example, the housing 102 is a first housing. The airflow device includes the first housing 102 and a second housing that is operationally and structually identical to housing 102. First housing 102 is configured to encompass a first ear of the user and the second housing is configured to encompass a second ear of the user.

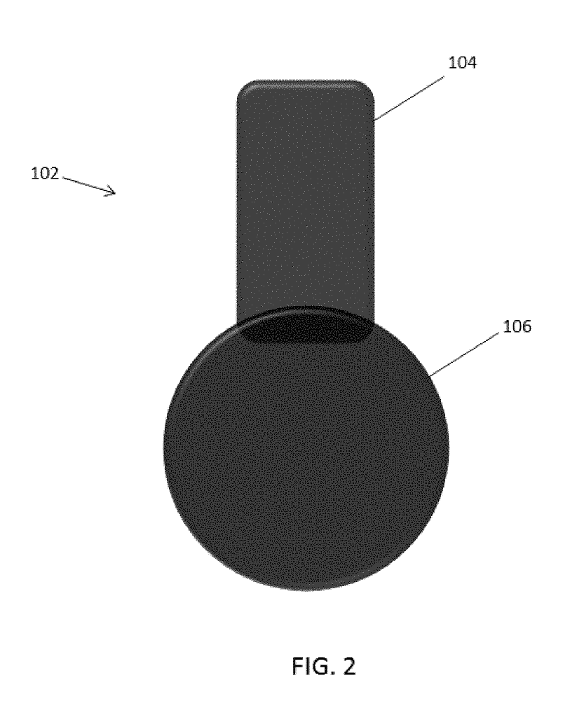

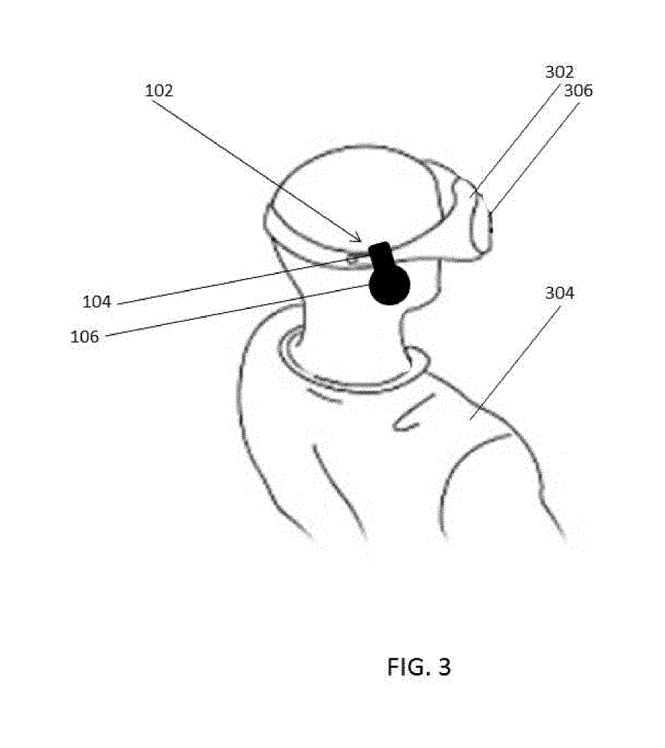

FIG. 2 illustrates an external view of the housing 102, in accordance with an exemplary embodiment. The housing 102 includes the arm 104 coupled to the circular base 106. The circular base 106 configured to at least substantially overlay an ear of a user, as shown in FIG. 3.

FIG. 3 illustrates the housing 102 attached to a virtual reality headset 302 worn by a user 304 in an exemplary embodiment. The circular base 106 is configured to be substantially aligned with an ear of the user 304 when used with the virtual reality headset 302. The virtual reality headset 302 includes a display device 306 adapted to display a virtual environment. The display device 306 may have two separate displays which can be operated in such a way that a virtual environment can be stereoscopically displayed, so that a user of the virtual reality headset obtains a three-dimensional impression of the displayed virtual environment. The virtual reality headset 302 is communicatively coupled to an image source that provides the image-sequence information and the display device 306 is configured to display the image-sequence information.

In one embodiment, the housing 102 and/or the virtual reality headset 302 includes one or more position sensors, such as altimeters, to detect a respective spatial position and change in the spatial position of the virtual reality headset 302. In another embodiment, the virtual reality headset 302 may be embedded in a system that includes a detection device. The detection device 24 can, for example, be designed as a camera system by means of which the position of the virtual reality headset 302 can be detected.

In one embodiment, the housing 102 is integrated with the virtual reality headset 302. In another embodiment, the housing 102 of the airflow device includes at least one connector connecting the housing 102 to the virtual reality headset 302.

In an exemplary embodiment, housing 102 is a first housing. The airflow device includes the first housing 102 and a second housing that is structually identical to housing 102. First housing 102 is configured to encompass a first ear of the user and the second housing is configured to encompass a second ear of the user.

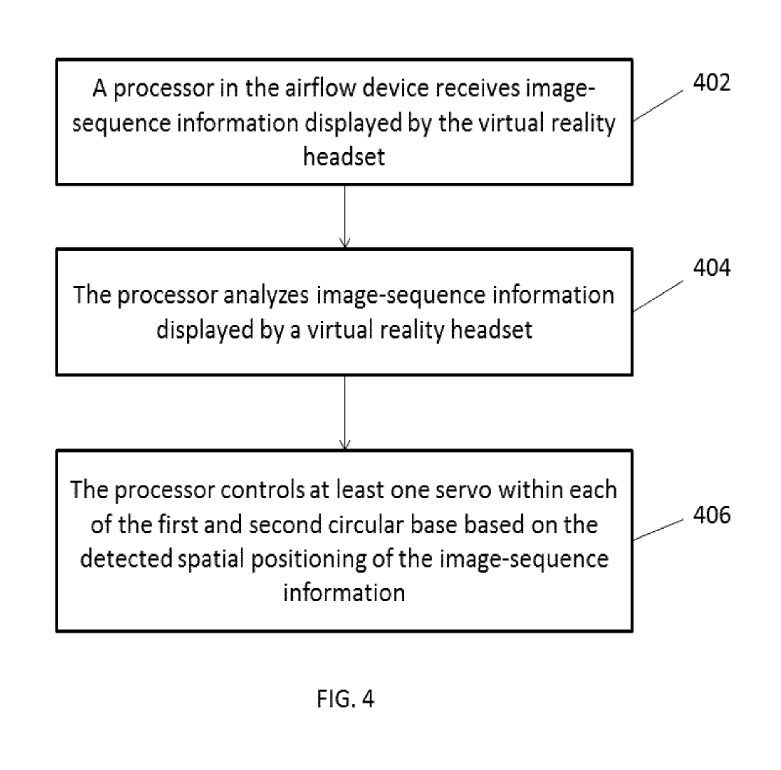

FIG. 4 is a flowchart illustrating an exemplary method for controlling an airflow device for a virtual reality headset to reduce motion sickness symptoms in a user, in accordance with an exemplary embodiment. At step 402, a processor in the airflow device receives image-sequence information displayed by the virtual reality headset. The airflow device includes a first and second housing respectively including a first arm and a second arm respectively coupled to a first and second circular base. Each of the first and second circular base further including at least one air outtake port.

At step 404, the processor analyzes image-sequence information displayed by a virtual reality headset. The virtual reality headset is communicatively coupled to an image source that provides the image-sequence information. The virtual reality headset includes an airflow device comprising a first and second housing respectively including a first arm and a second arm respectively coupled to a first and second circular base. The first circular base is configured to at least substantially overlay a first ear of a user. The second circular base is configured to at least substantially overlay a second ear of the user. Each of the first and second circular base further includes at least one air outtake port configured to release air from the first or second circular base such that the airflows by the ear of the user in a single direction. At least one servo within each of the first and second circular base control the airflow to the at least one air outtake port.

At step 406, the processor controls the at least one servo within each of the first and second circular base based on the detected spatial positioning of the image-sequence information to release air from the first or second circular base via the at least one outtake port such that the air flows by the ear of the user in a single direction. The processor controls the at least one servo such that a direction of the airflow is opposite to a virtual direction of movement of the user as determined by the image-sequence information. In an exemplary embodiment, each of the first and second circular base includes four air outtake ports. Each air outtake port is configured to release air from the circular base in a different direction over the first or second ear of the user, each port direction configured to emit air in a direction approximately 90 degrees different from the nearest adjacent port.

The description herein is presented to enable any person skilled in the art to create and use a computer system configuration and related method and systems for generating virtual items within a facility. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1) An airflow device for a virtual reality headset to reduce motion sickness symptoms in a user, the airflow device comprising:
a first and second housing respectively including a first arm and a second arm respectively coupled to a first and second circular base, the first circular base configured to at least substantially overlay a first ear of a user, the second circular base configured to at least substantially overlay a second ear of the user;
a first and second air intake port in each of the first and second arm for respectively channeling air into the first or second housing;
at least one motor within each of the first and second arm for accelerating airflow and increasing air pressure;
at least one air outtake port in each of the first and second circular base, the at least one air outtake port configured to release air from the first or second circular base such that the air flows by the ear of the user in a single direction;
at least one servo within each of the first and second circular base for controlling the airflow to the at least one air outtake port; and
a processor communicatively coupled to the virtual reality headset and configured to analyze image-sequence information displayed by the virtual reality headset to control the at least one servo, wherein the control of the at least one servo is dependent on detected spatial positioning of the image-sequence information.

2) The airflow device of claim 1, wherein each of the first and second circular base includes four air outtake ports, each air outtake port configured to release air from the circular base in a different direction over the first or second ear of the user, each port direction configured to emit air in a direction approximately 90 degrees different from the nearest adjacent port.

3) The airflow device of claim 1, wherein the first and second circular base each includes a plurality of air outtake ports each with an airflow controlled by a separate servo located within the housing.

4) The airflow device of claim 1, wherein the housing is integrated with the virtual reality headset.

5) The airflow device of claim 1, wherein the first and second circular base are configured to encompass the first or second ear of the user.

6) The airflow device of claim 1, each of the first and second housing further comprising:
at least one connector connecting the first or second housing to the virtual reality headset, wherein the first or second circular base is configured to be substantially aligned with the first or second ear of the user when the housing is connected to the virtual reality headset.

7) The airflow device of claim 1, further comprising:
a head mounted band attached to the first or second housing, wherein the head mounted band is configured to be worn on a head of the user and each of the first and second circular base is configured to be substantially respectively aligned with the first or second ear of the user.

8) The airflow device of claim 1, wherein the processor is configured to control the at least one servo such that a direction of the airflow is opposite to a virtual direction of movement of the user as determined by the image-sequence information.

9) The airflow device of claim 1, further comprising at least one additional motor within each of the the first and second circular base for accelerating airflow and increasing air pressure within the first and second circular base.

10) A method for controlling an airflow device for a virtual reality headset to reduce motion sickness symptoms in a user, the method comprising:
receiving image-sequence information displayed by the virtual reality headset at a processor in the airflow device, the airflow device including a first and second housing respectively including a first arm and a second arm respectively coupled to a first and second circular base, each of the first and second circular base further including at least one air outtake port;
analyzing, via the processor, the image-sequence information displayed by a virtual reality headset; and
controlling, via the processor, at least one servo within each of the first and second circular base based on a detected spatial positioning of the image-sequence information to release air from the first or second circular base via the at least one outtake port such that the air flows by the ear of the user in a single direction.

11) The method of claim 10, further comprising:
displaying, via the virtual reality headset, the image-sequence information, wherein the virtual reality headset is coupled to an image source that provides the image-sequence information.

12) The method of claim 10, further comprising connecting the housing to the virtual reality headset, wherein the circular base is configured to be substantially aligned with the ear of the user when the housing is connected to the virtual reality headset.

13) The method of claim 10, further comprising attaching the housing to a head mounted band, wherein the head mounted band is worn on a head of the user with the circular base configured to be substantially aligned with the ear of the user.

14) The method of claim 10, wherein controlling, via the processor, the at least one servo such that a direction of the airflow is opposite to a virtual direction of movement of the user as determined by the image-sequence information.

15) The method of claim 10, further comprising including at least one additional motor within the circular base for accelerating airflow and increasing air pressure within the circular base.

16) The method of claim 10, wherein the circular base includes four air outtake ports, the method further comprising releasing air from an air outtake port of the four air outtake ports in a north, south, east or west direction over the ear of the user.

17) A system to reduce motion sickness symptoms in a user, the system comprising:
a virtual reality headset; and
an airflow device for the virtual reality headset, the airflow device comprising:
a first and second housing respectively including a first arm and a second arm respectively coupled to a first and second circular base, the first circular base configured to at least substantially overlay a first ear of a user, the second circular base configured to at least substantially overlay a second ear of the user;
a first and second air intake port in each of the first and second arm for respectively channeling air into the first or second housing;
at least one motor within each of the first and second arm for accelerating airflow and increasing air pressure;
at least one air outtake port in each of the first and second circular base, the at least one air outtake port configured to release-air from the first or second circular base such that the air flows by the ear of the user in a single direction;
at least one servo within each of the first and second circular base for controlling the airflow to the at least one air outtake port; and
a processor communicatively coupled to the virtual reality headset and configured to analyze image-sequence information displayed by the virtual reality headset to control the at least one servo, wherein the control of the at least one servo is dependent on detected spatial positioning of the image-sequence information.

18) The system of claim 17, wherein each of the first and second circular base includes four air outtake ports, each air outtake port configured to release air from the circular base in a different direction over the first or second ear of the user, each port direction configured to emit air in a direction approximately 90 degrees different from the nearest adjacent port.

19) The system of claim 17, wherein the first and second circular base each includes at least two air outtake ports, each air outtake port with an airflow controlled by a separate servo located within the housing.

20) The system of claim 17, wherein the housing is integrated with the virtual reality headset.
